(19) United States
(12) Patent Application Publication
(10) Pub. No.: US 2025/0278348 A1
(43) Pub. Date: Sep. 4, 2025

(54) Systems and Methods for Ephemeral Processing of High Cardinality Data

(71) Applicant: Uber Technologies, Inc., San Francisco, CA (US)

(72) Inventors: Arnav Balyan, Gurgaon (IN); Amruth Sampath, Bengaluru (IN)

(21) Appl. No.: 18/594,637

(22) Filed: Mar. 4, 2024

(51) Int. Cl. G06F 11/34; G06F 16/174

(52) U.S. Cl. CPC G06F 11/3476; G06F 16/1748

(57) ABSTRACT

Systems and methods for ephemeral processing of high cardinality data. The system can receive log data indicative of metrics associated with a computing system, wherein the log data is received by an aggregation layer. The method includes aggregating the log data by deduplicating the plurality of logs using one or more aggregation parameters, wherein the one or more aggregation parameters are configurable to increase or decrease a level of deduplication. The method includes, in response to aggregating the log data, determining deduplicated log data including one or more unique logs indicative of unique metrics associated with the computing system. The method includes transmitting the deduplicated log data to a storage system.

### FIELD

The present disclosure generally relates to techniques for processing data received by a computing system.

### BACKGROUND

Log data may include various types of information associated with a computing system. For instance, log data may record all events occurring within a computing system, an application, or on a network device. Logging may be enabled to facilitate the monitoring and analysis of log data. However, processing and storing large quantities of logs may increase storage costs and consume considerable computing resources adversely impacting the computing system.

### SUMMARY

Aspects and advantages of embodiments of the present disclosure will be set forth in part in the following description, or may be learned from the description, or may be learned through practice of the embodiments.

In an example aspect, the present disclosure provides an example computer-implemented method. The example computer-implemented method includes receiving, from one or more client devices, log data including a plurality of logs indicative of metrics associated with a computing system, wherein the log data is received by an aggregation layer. The method includes aggregating the log data by deduplicating the plurality of logs using one or more aggregation parameters, wherein the one or more aggregation parameters are configurable to increase or decrease a level of deduplication. The method includes, in response to aggregating the log data, determining deduplicated log data including one or more unique logs indicative of unique metrics associated with the computing system. The method includes transmitting the deduplicated log data to a storage system.

In some implementations, the log data includes at least one of: (i) a higher throughput than the deduplicated log data or (ii) a higher cardinality than the deduplicated log data.

In some implementations, the aggregation layer is provided as part of a network layer.

In some implementations, the log data is ephemerally received by the aggregation layer.

In some implementations, the method includes accessing the deduplicated data from the storage system. In some implementations, the method includes computing analytics data based on the deduplicated data, the analytics data being associated with the log data.

In some implementations, the one or more aggregation parameters includes metadata associated with the plurality of logs.

In some implementations, the metadata includes at least one of: (i) a time stamp or (ii) a log type associated with respective logs of the plurality of logs.

In some implementations, the method includes determining the aggregation layer is unavailable to receive additional log data. In some implementations, the method includes, based on determining the aggregation layer is unavailable to receive the additional log data, transmitting the additional log data to the storage system.

In some implementations, determining the aggregation layer is unavailable to receive the additional log data includes determining one or more faults associated with the aggregation layer, wherein the one or more faults are indicative of a fault tolerance.

In another aspect, the present disclosure provides an example computing system. The example computing system includes one or more processors and one or more non-transitory, computer readable medium storing instructions that are executable by the one or more processors to cause the computing system to perform operations. The example operations include receiving, from one or more client devices, log data including a plurality of logs indicative of metrics associated with a computing system, wherein the log data is received by an aggregation layer. The example operations include aggregating the log data by deduplicating the plurality of logs using one or more aggregation parameters, wherein the one or more aggregation parameters are configurable to increase or decrease a level of deduplication. The example operations include in response to aggregating the log data, determining deduplicated log data including one or more unique logs indicative of unique metrics associated with the computing system. The example operations include transmitting the deduplicated log data to a storage system.

In some implementations, the log data includes at least one of: (i) a higher throughput than the deduplicated log data or (ii) a higher cardinality than the deduplicated log data.

In some implementations, the aggregation layer is provided as part of a network layer.

In some implementations, the log data is ephemerally received by the aggregation layer.

In some implementations, the operations include generating, accessing the deduplicated log data from the storage system. In some implementations, the operations include accessing the deduplicated log data from the storage system.

In some implementations, the one or more aggregation parameters comprises metadata associated with the plurality of logs.

In some implementations, the metadata includes at least one of: (i) a time stamp or (ii) a log type associated with respective logs of the plurality of logs.

In some implementations, the operations include determining the aggregation layer is unavailable to receive additional log data. In some implementations, the operations include, based on determining the aggregation layer is unavailable to receive the additional log data, transmitting the additional log data to the storage system.

In some implementations, determining the aggregation layer is unavailable to receive the additional log data includes determining one or more faults associated with the aggregation layer, wherein the one or more faults are indicative of a fault tolerance.

In another example aspect, the present disclosure provides for one or more example non-transitory computer-readable medium storing instructions that are executable to cause one or more processors to perform operations. The example operations include receiving, from one or more client devices, log data including a plurality of logs indicative of metrics associated with a computing system, wherein the log data is received by an aggregation layer. The example operations include aggregating the log data by deduplicating the plurality of logs using one or more aggregation parameters, wherein the one or more aggregation parameters are configurable to increase or decrease a level of deduplication. The example operations include in response to aggregating the log data, determining deduplicated log data including one or more unique logs indicative of unique metrics associated with the computing system. The example operations include transmitting the deduplicated log data to a storage system.

In some implementations, the log data includes at least one of: (i) a higher throughput than the deduplicated log data or (ii) a higher cardinality than the deduplicated log data.

Other example aspects of the present disclosure are directed to other systems, methods, apparatuses, tangible non-transitory computer-readable media, and devices for performing functions described herein. These and other features, aspects and advantages of various implementations will become better understood with reference to the following description and appended claims. The accompanying drawings, which are incorporated in and constitute a part of this specification, illustrate implementations of the present disclosure and, together with the description, serve to explain the related principles.

### BRIEF DESCRIPTION OF THE DRAWINGS

Detailed discussion of embodiments directed to one of ordinary skill in the art are set forth in the specification, which makes reference to the appended figures, in which:

FIG. 1 depicts an example computing ecosystem according to example aspects of the present disclosure.

FIG. 2 depicts an example data flow pipeline according to example aspects of the present disclosure.

FIG. 3 depicts an example data flow pipeline according to example aspects of the present disclosure.

FIG. 4 depicts an example system architecture according to example aspects of the present disclosure.

FIG. 5 depicts an example data flow pipeline according to example aspects of the present disclosure.

FIG. 6 depicts an example flowchart diagram of an example method according to example aspects of the present disclosure.

FIG. 7 depicts an example computing ecosystem according to example aspects of the present disclosure.

### DETAILED DESCRIPTION

Generally, the present disclosure is directed to techniques for processing high cardinality data, reducing throughput, and decreasing the use of storage resources for computing systems. For example, techniques according to the present disclosure provide an improved log consumption and processing model using an aggregation layer to deduplicate high cardinality log data prior to storing the logs. The processes described herein help to reduce ingestion throughput and storage costs for a computing system. The system of the present disclosure can more effectively consume data streams which include logs associated with the computing system by directly aggregating duplicative logs on a network layer and deduplicating the logs without the need to save the raw log data.

For example, in a server-client architecture for an application, multiple clients may send and receive messages, data, or other types of information to and from servers that run, provide, or implement the application. The data can include high cardinality data, such as event logs which increases the throughput of traffic between the clients and the server for the same type of log. As described herein, high cardinality data refers to data that has a large number of unique values or entities (e.g., a common column or field that can have many possible values). The large number of unique values in log data may represent a significant level of repetition and very little diversity. For example, a log file may be generated for a particular event which occurs hundreds or thousands of times per second. The only variance in the log files may include the time stamp (e.g., distinct value) indicating the time at which the event occurred. Handling a large number of distinct values over time may require complex data structures and algorithms to maintain performance. Further, storing duplicative logs where only one value (e.g., a column, field, etc.) is different can sharply increase storage costs. For instance, the degree of duplication may be a single unique log compared to hundreds of duplicative logs. To address these problems, the technology of the present disclosure allows for logs to be aggregated at the network layer (e.g., where traffic from clients are received) and deduplicated prior to being stored. Deduplication at the network layer reduces the overall throughput of the computing system by avoiding the processing of duplicative logs. Moreover, storing only unique log data reduces storage costs by also avoiding the storage of the duplicative logs.

According to example embodiments of the present disclosure, the aggregation layer may include software configured to receive event data from one or more clients associated with the computing system. The aggregation layer may be standalone software deployed on top of the network layer or may be included as a configuration of the network layer itself. For instance, the aggregation layer may include a distributed processing engine which receives log data including a plurality of log files and analyzes the log data to determine log characteristics. The log characteristics may indicate that the log is duplicative of other log files within the log data. By way of example, log data may include a number of log files (e.g., sixty log files) associated with a client device. The sixty log files may include event data indicating that a user (e.g., user associated with the client device) took an action (e.g., action_id). The processing engine of the aggregation layer may analyze the sixty log files and determine based on log characteristics that the actions (e.g., action_id) associated with the sixty log files include three distinct actions (e.g., action_id is distinct value) taken by the user. As such the sixty log files may be aggregated and reduced to only three log files (e.g., three distinct log files per action per user).

Aggregating the log data may include grouping or filtering unique log files until only unique log data remains. As such, log data may have a higher cardinality and create a higher throughput than aggregated unique log data. Duplicative logs may be indicated by metadata or encoded parameters which indicate a number of times a duplicate log was received, or the unique values associated with a particular group of log files. For instance, one or more aggregation parameters may be configured to control the level of aggregation. Aggregation parameters may divide an event data stream (e.g., stream of event logs from one or more clients) based on a parameter. An example aggregation parameter can include a parameter such as time. By way of example, an aggregation parameter may be configured to aggregate log data based on a common timestamp. For instance, log data including one hundred logs files across four unique timestamps may be aggregated and reduced to four log files based on the unique timestamps. While examples herein describe timestamps as an aggregation parameter, the present disclosure is not limited to such an embodiment. Aggregation parameters may include any constant field or metadata associated with log data.

Once the log data has been aggregated, unique log data may be generated and consumed by an event processing or event logging system to expose the unique log data to downstream systems. For example, the unique log data may be stored and accessed by downstream systems for analytics purposes, root causes analysis (RCA), troubleshooting, and the like. In some examples, the aggregation layer may be unavailable (e.g., due to network outages, security incidents, etc.). In such cases, where the aggregation layer becomes unavailable, the log data may be stored for later processing. For instance, logs stored while the aggregation layer is unavailable may be read from storage and processed to continuously reduce the storage costs for the computing system.

The technology of the present disclosure may provide several benefits and technical effects. For instance, the technology of the present disclosure decreases the overall throughput and use of computing resources of a computing system by reducing the amount of log data processed and stored. As such, the technology may increase the overall stability, performance, and reliability of the application system by limiting the probability of incidents or outages due to high throughput or increased resource utilization. The technology of the present disclosure may also help to increase the flexibility of application systems without impacting performance due to the discovery of new client event data streams. Moreover, by reducing the overall throughput of the system data and amount of data stored by the system, the technology of the present disclosure may reduce storage costs and application complexity by simplifying high cardinality data.

Reference now will be made in detail to embodiments, one or more example(s) of which are illustrated in the drawings. Each example is provided by way of explanation of the embodiments, not limitation of the present disclosure. In fact, it will be apparent to those skilled in the art that various modifications and variations may be made to the embodiments without departing from the scope of the present disclosure. For instance, features illustrated or described as part of one embodiment may be used with another embodiment to yield a still further embodiment. Thus, it is intended that aspects of the present disclosure cover such modifications and variations.

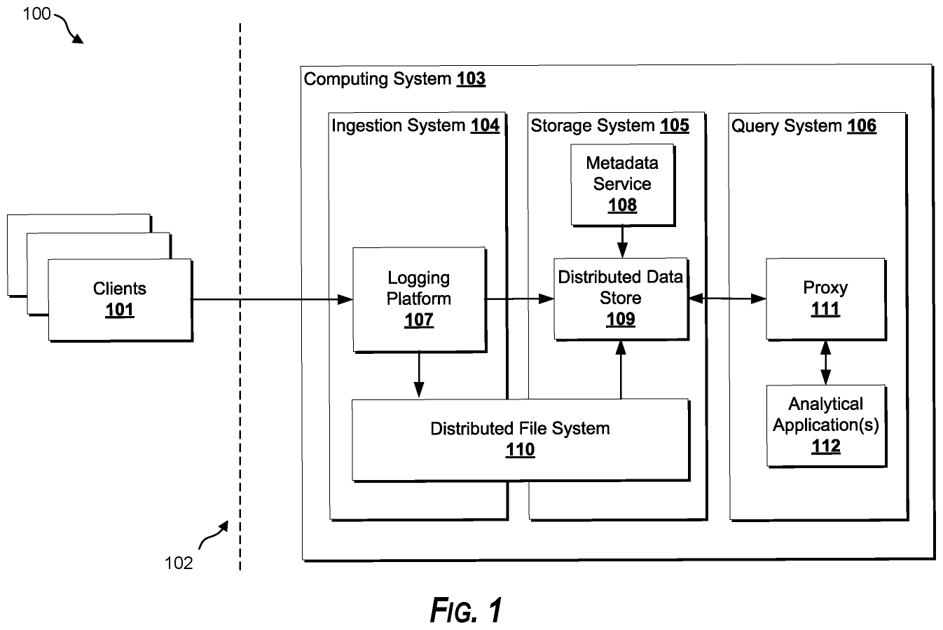

FIG. 1 depicts an example computing ecosystem according to example aspects of the present disclosure. The example computing ecosystem 100 may include clients 101 which generate log data and transmit the log data through a network layer 102 to a computing system 103. The computing system 103 may include an ingestion system 104 to ingest the log data, a storage system 105 which stores the log data, and a query system 106 which allows analytical applications 112 to query the log data.

With respect to examples as described herein, the system 100 may be implemented on a server, combination of servers, or a distributed set of computing devices which communicate over a network such as the Internet. For example, the system 100 may be distributed using one or more physical servers, virtual private servers, or cloud computing. In other examples, the system 100 may be implemented as a part of or in connection with the clients 101, where, for example, a distributed application (e.g., computing system 103) is architected using a client-server relationship including independent or dependent services (e.g., microservices, etc.) to communicate over one or more networks with application clients (e.g., clients 101).

Clients 101 can include desktop clients, web browsing clients, application clients, and the like. The clients 101 may be running on one or more client devices (e.g., desktop, mobile devices, etc.) and facilitate communications with one or more servers of the computing system 103. For instance, the clients 101 may include a client program (e.g., software) that consumes services provided by a server program (e.g., computing system 103). The clients 101 may request data or other services (e.g., microservices, etc.) from the one or more servers of the computing system 103 by calling functions in the server application (e.g., computing system 103) over one or more networks. The clients 101 may generate log data as a user interacts with the clients 101 on a client device and the clients 101 interact with the computing system 103. For instance, log data may be generated based on user actions, requests from the clients 101, client performance, network events, etc.

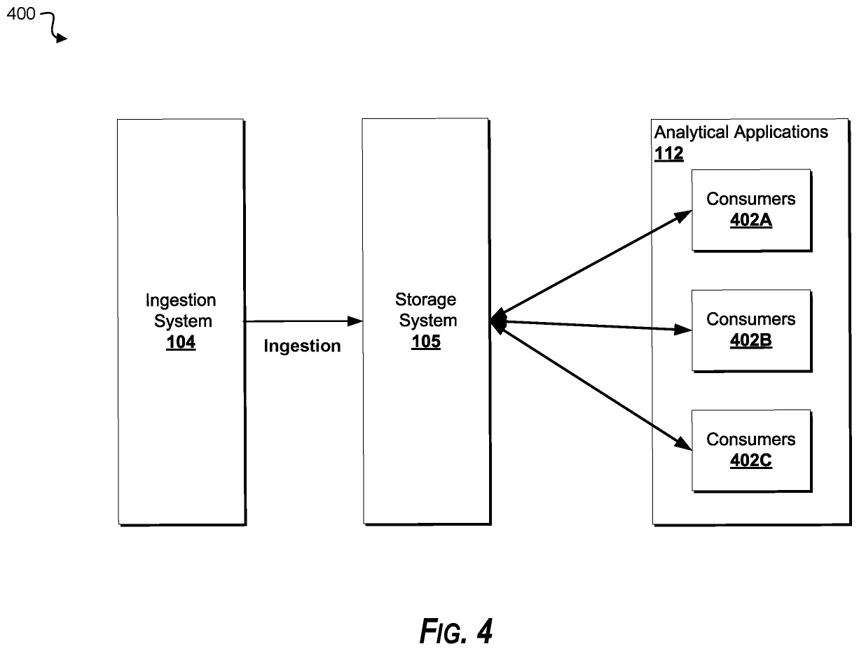

The log data may be transmitted through a network layer 102 along with requests (e.g., queries, API calls, etc.) to interact with the server program (e.g., computing system 103). Example log data may include availability logs (e.g., logs that track system performance and availability, etc.), resource logs (e.g., logs that indicate information on connectivity issues), security logs (e.g., logs that contain information regarding suspicious network activity, etc.), or any other type of log data. In some implementations, the computing system 103 may enable logging for the clients 101. Logging may enable the computing system 103 to capture one or more data streams (e.g., event log data) from the clients 101 and store the log data for analysis or further processing. In some implementations, a discovery computing system may be utilized to discover new clients 101 which will stream log data to the computing system 103. An example discovery computing system is further described with reference to FIG. 4.

Log data transmitted from clients 101 may be received and routed by a network layer 102. The network layer 102 handles the routing and sending of data between different networks on behalf of the computing system 103. For instance, clients 101 may be running on client devices connected to the computing system 103 over one or more networks. By way of example, the network layer 102 may receive requests, log data, etc., from clients 101 in the form of data packets, assemble the data packets, and determine the route for the requests or log data to reach the desired service (e.g., microservice, services, etc.) or destination internally within the computing system 103. The network layer 102 may utilize one or more network protocols such as IP, ICMP, etc. to facilitate the routing of data packets. Additionally, or alternatively, the network layer 102 may transmit data packets to clients 101 (e.g., in response to requests, etc.) or other computing systems over one or more networks. As such the network layer 102 may facilitate inbound and outbound communications between the computing system 103 and the clients 101 operating on one or more networks. In some implementations, the network layer 102 may be deployed to network infrastructure, including but not limited to routers, switches, and other network interfaces.

The computing system 103 may include software running on one or more servers. For instance, the computing system 103 may be implemented as a part of or in connection with services or microservices. By way of example, microservices may be deployed in a container (e.g., standalone software package for a software application) using a container service, or on VMs (virtual machines) within a shared network. A container service may be a cloud service that allows developers to upload, organize, run, scale, manage, and stop containers using container-based virtualization to orchestrate respective actions of the microservices. In some examples, a VM may include virtual computing resources which are not limited to a physical computing device.

The computing system 103 may include one or more subsystems. For instance, the computing system 103 may include an ingestion system 104. The ingestion system 104 may include software running on one or more servers of the computing system 103. The ingestion system 104 may be implemented using a virtual private cloud (VPC), container service, or may be deployed within a public cloud environment. The ingestion system 104 may be configured to ingest (e.g., receive, process, consume, etc.) data streams including log data. For instance, the ingestion system 104 may include a logging platform 107. In some implementations, the logging platform 107 may be implemented using a container service. The logging platform 107 may include a distributed event store and streaming service for event processing. A distributed event processing store and streaming service may generate streaming data pipelines to allow for transmission of data between multiple systems. By way of example, the logging platform 107 may generate one or more data stream pipelines to allow log data generated by clients to be transmitted (e.g., streamed) to a distributed data store 109 where the log data may be consumed for data analytics purposes.

As further described herein, the ingestion system 104 may ingest log data from clients 101 that have subscribed to the logging platform 107 (e.g., enabled logging). Data ingestion may include streaming various types of log data from multiple sources (e.g., clients 101, etc.) and storing the log data in a data store to be accessed and analyzed by analytical applications 112 using a distributed data store 109. Log data may include event logs, (e.g., logs that records network traffic and usage data), server logs (e.g., logs that track actions on a server), system logs (e.g., logs that occur within the operating system), or any type of log produced by a software application. In some examples, log data may include structured, semi-structured, and unstructured logs. Structured log data may include JSON (JavaScript Object Notation) logs. Semi-structured logs may include HTML (Hypertext Markup Language), XML (Extensible Markup Language), or any other markup languages. Unstructured log data may include large text files including strings which are intended for human reading.

The computing system 103 may include a storage system 105. The storage system 105 may include one or more systems and may be implemented using a virtual private cloud (VPC), container service, or may be deployed within a public cloud environment. For example, the storage system 105 may include a metadata service 108, a distributed data store 109, and a distributed file system 110.

The metadata service 108 may be a service in the form of software code that is used to define the names, data types, etc., for the columns of the distributed data store 109. In some examples, the metadata service 108 is deployed in a container. In some examples, the metadata service 108 may be deployed within the distributed data store 109. In other examples, the metadata service 108 may be deployed on a virtual machine. The metadata service 108 may implement a universal schema for the storage system 105. For instance, the clients 101 may generate high cardinality (e.g., repetitive) and variance (e.g., diverse) log data. By way of example, the clients 101 may generate high cardinality log data including repetitive log files where a single attribute or field (e.g., timestamp, client type, etc.) are different. High cardinality data may increase storage utilization due to the highly repetitive logs in which one or fewer attributes are different. In some examples, variance log data may be difficult to store in a single data store due to the differences in structure or format. The metadata service 108 may implement a universal schema such that repetitive log data which has been deduplicated and variance log data may be uniformly stored within the storage system 105. As such the storage system 105 may further distribute log data to secondary storage systems where the log data may be further processed or more accessible for downstream systems.

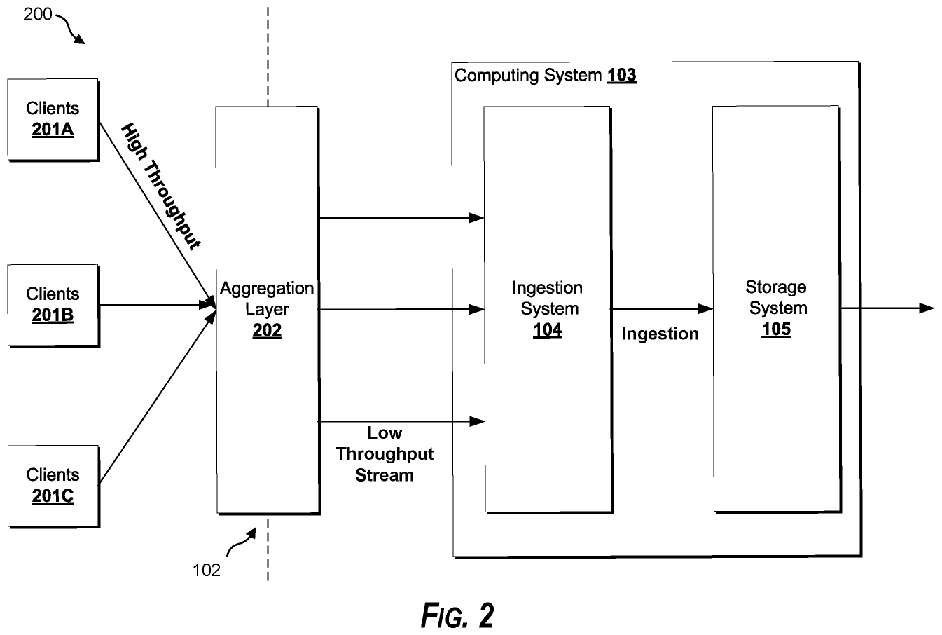

For example, an aggregation layer deployed near the network layer may receive log data generated by clients 101 and prior to being received by the ingestion system 104, deduplicate (e.g., aggregate) high cardinality log data. The aggregation layer may deduplicate the high cardinality log data and indicate the repetitive values as metadata or encoded values thereby reducing throughput for the computing system 103. An example of an aggregation layer is further described with reference to FIG. 2.

In some examples, the metadata service 108 may include a schemalesss implementation. For instance, the distributed datastore 109 may store high variance log data in a non-tabular format. For example, the metadata service 108 may define one or more customized views of the data. In some examples, the customized view may be based on the type of log data (e.g., structured, unstructured, etc.). In other examples, the customized view may be based on the index type of the log data (e.g., aggregated log data, etc.). The customized view may be based on a plurality of index types. As such the schemaless implementation may provide flexibility to store high variance or high cardinality logs.

The distributed data store 109 may be a storage system configured to receive and store data in a distributed manner. By way of example, the distributed data store 109 may include an online analytical processing data store (e.g., OLAP database). An online analytical processing data store may ingest log data from data streams (e.g., the logging platform 107) or from batch data sources (e.g., the distributed file system 110) and allow analytical applications 112 to deliver data analytics in real-time. In some examples, the distributed data store 109 may be implemented using a container service. For instance, the distributed data store 109 may be deployed across multiple clusters of servers or containers.

The storage system 105 may include a distributed file system 110. A distributed file system 110 may be any computer network where data is stored on more than one node (e.g., virtual machine, cluster of virtual machines, servers, etc.). For instance, the distributed file system 110 may include various types of nodes for storing data and segments with differing requirements. In some examples, the distributed file system 110 may include software that manages files in a storage system (e.g., storage system 105). Example distributed file systems 110 may include software that manages files stored in a data lake, data warehouse, etc. In some examples, the distributed file system 110 may include servers associated with the distributed data store 109. For instance, the distributed file system 110 may include real-time servers which store real-time data (e.g., data instantly available upon creation or processing) that may be accessed by the distributed data store 109.

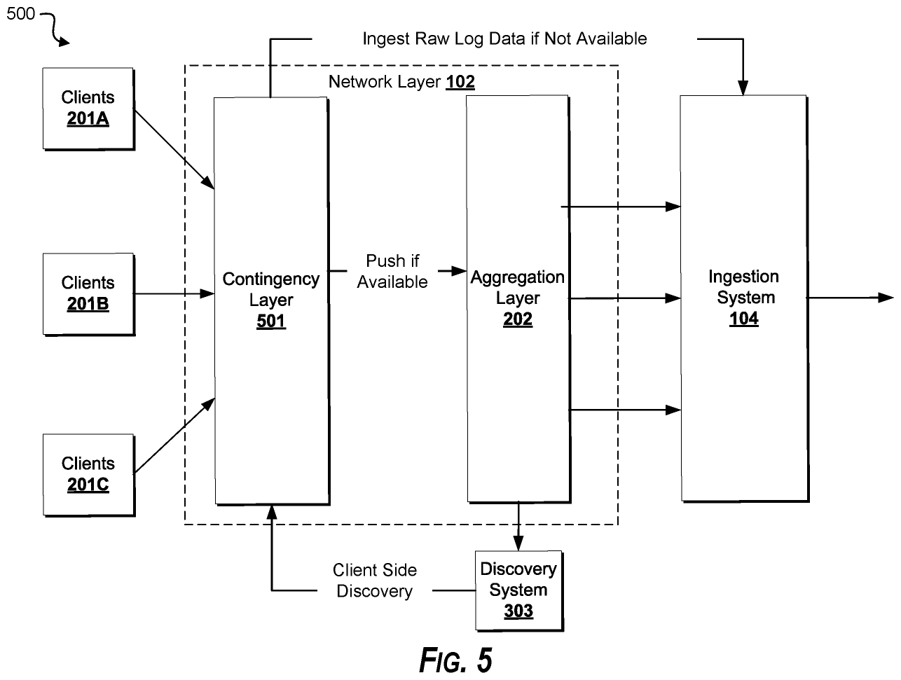

The distributed file system 110 may be associated with the ingestion system 104 and the storage system 105. For instance, the ingestion system 104 may share computing resources with the distributed file system 110 and the storage system 105. In some examples, the distributed file system 110 may manage severs and data for the logging platform 107. For instance, the logging platform 107 may consume a data stream including raw log data for later or offline processing. Later or offline processing may include aggregating log data at a time later than ingestion. For instance, in the event of a network disruption where log data cannot be aggregated at the network layer 102, raw log data may be ingested by the logging platform 107 and may be stored in offline servers to be processed at a time when normal operations resume. An example of offline processing is further described with reference to FIG. 5.

As described herein, the distributed file system 110 may store raw log data. Raw log data may include log files or messages which have not been aggregated. For example, the distributed file system 110 may include raw data log servers for storing the raw log data. In some examples, the logging platform 107 may receive a data stream and determine based on key values, log types, etc. that the logs should not be partitioned and directly store the raw log data within the distributed file system 110.

By way of example, the logging platform 107 may receive a data stream (e.g., log data), from a client 101, determine the topic for the log data is associated with offline data and partition the topic into offline segments. Offline segments may include data streams where the log data has not been deduplicated. In some examples, the logging platform 107 may determine the topic is associated with offline data based on not receiving previous queries of the same log type (e.g., key value, log type, etc.). In other examples, the logging platform 107 may be configured to determine offline data and partition offline segments in response to detecting a network event (e.g., outage, disruption, etc.).

The distributed file system 110 may include archive servers for storing archived segments. Archived segments may include data which has not been accessed or queried in a threshold time. For instance, the logging platform 107 may receive a data stream from clients 101 and partition the topic into segments across a cluster. In some examples, the segments may not be accessed for a threshold time and the segments may be transmitted to the distributed file system 110 and stored in an offline server rather than being made available in real-time via the distributed data store 109. In some examples, the segments may be stored in an archive server, where the segments will be archived. Log data stored in archived segments may be aggregated log data or raw log data.

In some examples, the logging platform 107 may be configured archive a data stream associated with a topic. For instance, the topic may include a key value (e.g., log type) which is rarely accessed. In some examples, the logging platform 107 may receive the data stream with an archive key value and directly partition segments within archive servers of the distributed file system 110.

The computing system 103 may include a query system 106 for receiving and facilitating queries from analytical applications 112. The query system 106 may include one or more systems and may be implemented using a virtual private cloud (VPC), container service, or may be deployed within a public cloud environment. For example, the query system 106 may include a proxy 111 and may include one or more analytical applications 112. The analytical applications 112 may include software used to analyze log data. In some examples, the analytical applications 112 may include self-service dashboards. For instance, the analytical applications 112 may be used to measure and improve the performance of business operations of the computing system 103 or provide business intelligence by analyzing log data produced by clients 101. In some examples, analytical applications 112 may be associated with a computing device with a user interface. An example of analytical applications 112 (e.g. consumers) is further described with reference to FIG. 4.

The proxy 111 may broker connections between the storage system 105 and the query system 106. The proxy 111 includes a server, cluster of servers, virtual machines, or a computing system which serves as an intermediary between a client (e.g., analytical applications 112, consumers, etc.) and a server (e.g., distributed data store 109, storage system 105, etc.). In some examples, the proxy 111 may be an API proxy. An API proxy may include an API gateway. In some examples, the API proxy may decouple the analytical application 112 from the backend services (e.g., clients 101, logging platform 107, distributed data store 109, etc.). In some examples, the proxy 111 may facilitate API calls (e.g., query for log data) between the analytical applications 112 and the storage system 105. For instance, the proxy 111 may handle identity management and authentication for query requests to ensure the security of the log data.

By way of example, the analytical applications 112 may receive a query request for log data. In some examples, the analytical applications 112 may automatically generate a query request (e.g., on page load of the analytical application 112). The proxy 111 may receive the query and validate the user (e.g., user associated with the analytical application 112) and ensure that the analytical application 112 (e.g., user authentication token, etc.) is authorized to access the data included in the query. In some examples, the proxy 111 may validate the identity of the user and authorize the access to the data by comparing user credentials or an API token to a security database. In some examples, the proxy 111 may validate the identity of the user and authorize the access to the data based on the classification of the log data. For instance, the log data may be public (e.g., view all access, etc.) and the proxy 111 may authorize access to the data. The proxy 111 may transmit the query to the distributed data store 109 where the query results may be aggregated from the logging platform 107 and the distributed file system 110. In some examples, the distributed data store 109 may transmit the query result through the proxy 111 to the analytical applications 112. An example of the distributed data store 109 facilitating query requests is further described with reference to FIG. 4.

In some example, the query system 106 may automatically request data from the storage system 105. For instance, the query system 106 may be scheduled to refresh data in the analytical application 112 on a specified cadence. In some examples, the query system 106 may request data on page load of the analytical application 112. In other examples, the query system 106 may request data when data reflected in the analytical application 112 has reached a threshold age. For example, when data for an analytical application 112 has not been refreshed for 8 hours, the query system 106 may automatically request updated data.

FIG. 2 depicts an example dataflow pipeline according to example aspects of the present disclosure. The following description of dataflow pipeline 200 is described within an example implementation in which an aggregation layer 202 ephemerally receives log data from a plurality of clients 201A-C and reduces a high traffic throughput by deduplicating the log data prior to ingestion.

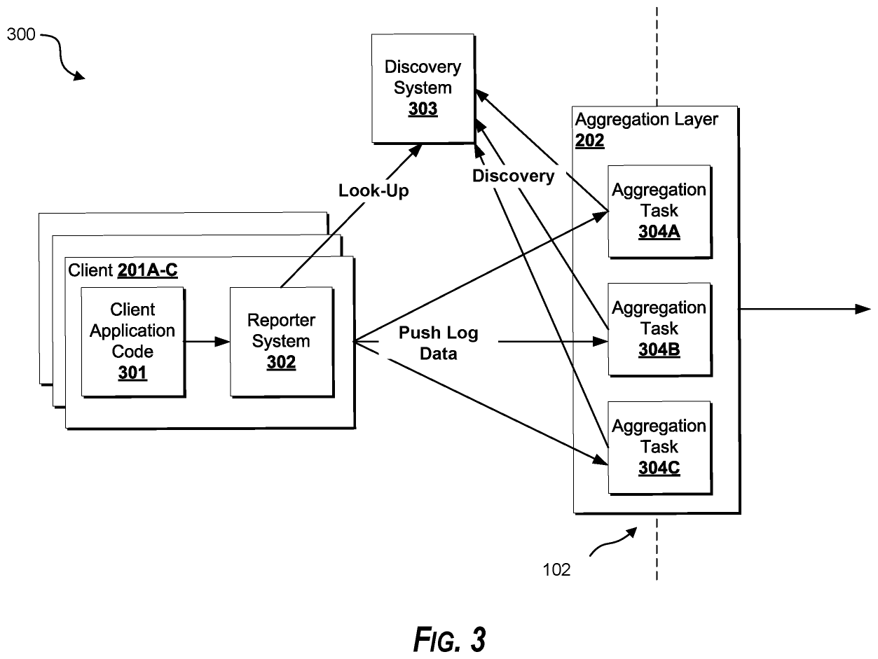

The aggregation layer 202 can include software deployed near the network layer 102. For instance, the aggregation layer 202 can include software deployed on top of the network layer 102 such that data (e.g., log data, requests, etc.) received by a computing system (e.g., computing system 103) may first pass through the aggregation layer 202. In some examples, the aggregation layer 202 can include software deployed directly behind the network layer 102. In other examples, the aggregation layer 202 may be implemented as a function of the network layer 102 itself. The aggregation layer 202 may include software configured to execute one or more aggregation tasks (e.g., function, computing job, etc.) associated with one or more clients 201A-C. For instance, respective clients 201A-C may push log data directly to an aggregation task of the aggregation layer 202 that has been configured to aggregate log data for the specific client 201A-C. An example of aggregation tasks is further described with reference to FIG. 3.

Log data produced by the plurality of clients 201A-C may generate high throughput. High throughput may indicate that a network (e.g., network layer 102) is transmitting or receiving a large amount of data per second. For instance, the plurality of clients 201A-C may be generating large amounts of high cardinality log data and, due to logging being enabled, transmitting the large amounts of log data to the computing system 103. High throughput can cause adverse impacts to the computing system 103 as more computing resources will be consumed to process and store the large amounts of log data.

As the plurality of clients 201A-C transmit log data to the computing system 103, the log data will first be ephemerally received by the aggregation layer 202 and processed prior to ingestion by the ingestion system 104. Ephemerally receiving log data may include allowing the raw log data pushed (e.g., transmitted) from the plurality of clients 201A-C to persist at the network layer 102 for a short period of time without storing the raw log data. By way of example, client 201A and client 201B may both generate thousands of logs per second indicating failed requests to a common service (e.g., service A) of the computing system 103. The thousands of logs per second may include identical log files with variance among the timestamp of the failed request and the client identifier (e.g., client_id, etc.). The volume of logs files included in the log data may increase the throughput of traffic to the computing system 103 over time as additional computing resources will be required to store and process the log data. The aggregation layer 202 may receive the high throughput data streams (e.g., streams of log data) and based on one or more aggregation parameters aggregate the raw log data streams to produce deduplicated log data with a low throughput.

For instance, the aggregation layer 202 may be configured to deduplicate log data based on one or more predefined aggregation parameters. While examples herein describe predefined aggregation parameters, the present disclosure is not limited to such embodiment. The aggregation parameters may include dynamically determined aggregation parameters. For instance, the aggregation layer 202, based on receiving log data over a threshold period of time may dynamically adjust or determine aggregation parameters based on highly duplicative log data.

Aggregation parameters can indicate one or more common log data attributes or features by which log data can be deduplicated. For example, the log data streams pushed to the computing system 103 from client 201A and client 201B may be deduplicated based on a “client id” attribute. In another example, aggregation parameters may include attributes or features such as log type. Failed requests for a common service (e.g., service A) may be associated with an error log type. As such, all error logs (e.g., log type) indicating the common service may be deduplicated based on the error log time for service A.

In yet another example, aggregation parameters may include attributes or features such as a timestamp. A timestamp indicates a day and time at which the log was generated for a particular event. Because timestamps may be a common attribute across all log data, log data can be deduplicated based on various times stamps (e.g., logs within a particular, hour, minute, second, etc.)

Log data received by the aggregation layer 202 may be analyzed to determine log attributes or features which satisfy the predetermined aggregation parameters and deduplicated based on the aggregation parameters. Deduplicating log data may include grouping log files of the log data which satisfy the aggregation parameter (e.g., timestamp, client identifier, etc.) and encoding the variance attributes or features. For instance, the variance data can include one or more unique fields or attributes associated with a plurality of log files.

By way of example, client 201B and 201C may each generate two thousand log files per minute indicating the same error message for service B of the computing system 103. The only difference in the thousands of log files per minute may include the client_id (e.g., client 201B, 20C, etc.) and the timestamp associated with the log files. Based on an aggregation parameter such as a timestamp, the aggregation layer 202 may be configured to aggregate (e.g., deduplicate) the thousands of log files per minute. For instance, the aggregation layer 202 may group together all log files pushed from the client 201B and 201C over a one minute span (e.g., timestamp aggregation parameter) and encode the client_id (e.g., client 201B and client 201C). The result may generate deduplicated log data where one log file may represent each of the two thousand log files pushed from the respective client 201B and 201C over the one minute span. As such, high throughput traffic pushed from client 201B and 201C may be reduced at the aggregation layer 202 (e.g., network layer 102) and a deduplicated log data may be transmitted to the computing system 103 as a low throughput data stream.

In some implementations, aggregation parameters may be used to increase or decrease a level of deduplication by the aggregation layer 202. For instance, the aggregation parameters may be configured such that more or less log data is grouped together. By way of example, a timestamp aggregation parameter can be used to increase or decrease a level of deduplication. For instance, a timestamp aggregation parameter indicating a five minute time interval (e.g., group log files based on timestamps within five minutes) may increase deduplication by grouping more log files in a larger time interval as opposed to a two or one minute time interval. For example, a data stream that includes ten thousand log files per minute will generate more deduplicated log files with a smaller timestamp aggregation parameter than a larger timestamp aggregation parameter.

The computing system 103 may receive the deduplicated log data and utilize the ingestion system 104 to process and store the log data. The deduplicated log data may be much smaller in size than raw log data received by the aggregation layer 202. For instance, the aggregation layer 202 may serve as a log processor and filter. The aggregation layer 202 may receive raw log data pushed from clients 2012A-C and generate deduplicated log data with a lower throughput. The deduplicated log data may also be much smaller in size than the raw log data due to the removal of duplicate log files. As such, the deduplicated log data may be stored in the storage system 105 using less storage capacity.

FIG. 3 depicts an example dataflow pipeline according to example aspects of the present disclosure. The example dataflow pipeline 300 is described with an example implementation in which a discovery system 303 is utilized to concatenate data streams pushed from clients 201A-C with one or more aggregation tasks 304A-C of an aggregation layer 202. The aggregation layer 202 may utilize the discovery system 303 to discover new clients 201A-C or other computing systems which intend to stream log data to the computing system 103.

For instance, the clients 201A-C can include client application code 301 which enables the clients 201A-C to render an application interface (e.g., on client device), execute application tasks, communicate (e.g., authenticate, send/receive requests, etc.), etc., with the computing system 103 over one or more networks. The clients 201A-C can also include a reporter system 302 to notify the discovery system 303 of an intent to stream log data (e.g., logging enabled). The reporter system 302 may include software configured to monitor the software (e.g., client application code 301) of the clients 201A-C and serve as a client logger. A client logger may be used to troubleshoot and debug software issues, as well as to gather data for analysis and performance optimization. A client logger may also be used to monitor the usage and behavior of client software by end users. The reporter system 302, once logging as been enabled, may be used to look up one or more assigned aggregation tasks 304A-C within the aggregation layer 202 to which log data generated by the client 201A-C should be pushed.

The discovery system 303 may include software running on one or more servers. For instance, the discovery system 303 may be implemented as a part of or in connection with services or microservices associated with the computing system 103. By way of example, the discovery system 303 may be deployed in a container (e.g., standalone software package for a software application) using a container service, or on VMs (virtual machines) within a shared network. A container service may be a cloud service that allows developers to upload, organize, run, scale, manage, and stop containers using container-based virtualization to orchestrate respective actions of the microservices. In some examples, a VM may include virtual computing resources which are not limited to a physical computing device.

The discovery system 303 may be configured to track aggregation tasks 304A-C that are available to receive a data stream from one or more clients 201A-C. For instance, the discovery system 303 may serve as a broker between the clients 201A-C and the aggregation layer 202. Because the aggregation layer is deployed near the network layer 102, aggregation tasks 304A-C may be ephemeral in nature. For example, aggregation tasks 304A-C may include software running in one or more containers which run for a period of time (e.g., to perform one or more aggregation tasks) and terminate. As such, aggregation tasks 304A-C may be dynamically created based on the number of clients 201A-C or other computing systems transmitting log data to the computing system 103.

By way of example, the plurality of clients 201A-C may respectively generate log data. For instance, one or more users may each interact with the plurality of clients 201A-C via a client device. The client application code 301, in response to the user's interaction may generate a series of requests, log files, etc. The reporter system 302 may log the activity of the client application code 301 and notify the discovery system 303 of an intent to stream log data to the computing system 103. The discovery system 303 may indicate that aggregation tasks 304A-C are available to receive the log data and the plurality of clients 201A-C may push the log data directly to the aggregation layer 202 (e.g., aggregation tasks 304A-C) where the log data may be deduplicated at the network layer 102 prior to being ingested and stored by the computing system 103.

In some examples, the aggregation tasks 304A-C may query the plurality of clients 201A-C. For instance, the discovery system 303 may store a registry of clients (e.g., of the plurality of clients 201A-C) which have logging enabled. In the event of network disruption or an error (e.g., aggregation tasks 304A-C fail to run) the aggregation layer 202 may query (e.g., discover) clients 201A-C which have transmitted log data during the period of disruption or error. In some examples, the aggregation layer 202 (aggregation tasks 304A-C) may process log data previously transmitted to the computing system during the period of disruption. An example of processing log data pushed from the clients 201A-C during a period of disruption is further described with reference to FIG. 5.

FIG. 4 depicts an example dataflow pipeline according to example aspects of the present disclosure. The example dataflow pipeline 400 is described with an example implementation in which one or more consumers 402A-C associated with an analytical application 112 retrieve data from the storage system 105. The consumers 402A-C may include software used to analyze log data stored in the storage system 105 using the analytical application 112. For instance, the analytical application 112 may be a centralized application running on one or more servers of the query system 106. The consumers 402A-C may include self-service dashboards, analytical graphs, interactive charts, etc. which consume data and analytical information facilitated by the analytical application 112. For instance, the consumers 402A-C may be used to measure and improve the performance of business operations or provide business intelligence by analyzing data logs (e.g., deduplicated log files) produced by clients (e.g., clients 101, clients 201A-C, etc.).

Consumers 402A-C may be associated with one or more computing devices. For instance, the computing device may be associated with a respective consumer 402A-C which renders the analytical applications 112 via a user interface. The computing device may be any type of computing device, such as a smartphone, tablet computer, laptop computer, VR or AR headset device, and the like. As such, the computing device may include components such as a microphone, a camera, a satellite receiver, and a communication interface to communicate with external entities using any number of wireless communication protocols. In some examples, the computing device may store an instance of the consumers 402A-C in a local memory to access the analytical application 112. In some examples, the memory may store additional applications executable by one or more processors of the computing device, enabling access and interaction with one or more servers (e.g., query system 106, storage system 105, etc.) over one or more networks.

In some examples, the computing device may communicate with the query system 106 over one or more networks. By way of example, the analytical applications 112 may be stored on one or more servers of the query system 106 and enable consumer 402A-C access. The computing devices may communicate via the consumers 402A with the analytical application 112 by communicating over one or more networks (e.g., with the servers of the query system 106). In some examples, the computing devices 407 may display the analytical applications 112 on the user interface of the computing device. For instance, the computing devices 407 may access and display the analytical applications 112 over a network such as the internet.

In some examples, the computing devices may be associated with one or more users. For instance, a user may interact with the consumers 402A-C and display the analytical application 112 on the user interface of the computing device. In some examples, the user may submit a search query for log data stored in the storage system 105. For instance, using the consumers 402A-C, a user may access the analytical application 112 and may generate a search query. The query may return the requested log data from the storage system 105 and apply any defined analytical functions to generate a view via the user interface.

In other examples, the analytical applications 112 automatically generate a search query and expose the results to the consumers 402A-C. For instance, upon accessing (e.g., page load) the consumers 402A-C, the analytical applications 112 may generate a search query to retrieve log data needed to populate one or more user interface elements (e.g., analytical graphs, charts, dashboards, etc.) of the consumers 402A-C. While examples herein describe consumers 402A-C in the context of performing data analytics, the present disclosure is not limited to such embodiment. Consumers 402A-C may access stored log data for other purposes including, but not limited to troubleshooting, root-cause-analysis (RCA), trend monitoring, regulatory compliance, etc.

FIG. 5 depicts an example data flow pipeline according to example aspects of the present disclosure. The example dataflow pipeline 500 is described with an example implementation in which a contingency layer 501 checks to determine whether the aggregation layer 202 is available prior to pushing log data from clients 201A-C to the aggregation layer 202. The example contingency layer 501 may serve as a contingency function in the event of a period or partial period of disruption for the aggregation layer 202, network layer 102, computing system 103, etc.

The contingency layer 501 may include software deployed near the network layer 102. For instance, the contingency layer 501 may be deployed on top of the aggregation layer 202 or as a function of the aggregation layer 202. In some examples, the contingency layer 501 may be integrated as a function of the network layer 102. In other examples, the contingency layer 501 may be deployed in a container as a stand along function. For instance, the contingency layer 501 may be triggered as a standard function which must resolve as true (e.g., aggregation layer 202 available, etc.) before log data can be pushed to the aggregation layer 202. In the event the contingency layer 501 determines the aggregation layer 202 is unavailable, the contingency layer 501 may be configured to bypass the aggregation layer 202 and route the raw log data streams directly to the ingestion system 104 to be processed and stored in the storage system 105. The raw log data streams may include a higher throughput for the computing system 103 and increase storage utilization due to its high cardinality and duplicative characteristics.

By way of example, the plurality of clients 201A-C may generate log data and attempt to push the log data to the computing system 103 for processing and storage. The contingency layer 501 may be configured to detect whether the aggregation layer 202 (e.g., aggregation computing tasks 304A-C) are available to receive the log data streams. For instance, the contingency layer 501 may access the discovery system 303 to determine whether aggregation tasks 403A-C are available. In some implementations, no aggregation tasks 403A-C may be available, which can be indicative of a complete disruption period. In other implementations, the number of aggregation tasks 403A-C may be available to aggregate log data may be less than what is required to aggregate the volume and number of data streams intending to push log data to the computing system 103 (e.g., partial disruption period.). Once determining a period or partial period of disruption, the contingency layer 501 may route the raw log data streams directly to the ingestion system 104.

The contingency layer 501 may periodically check (e.g., query, poll, etc.) the discovery system 303 to determine whether a period or partial period of disruption exists. In some implementations, the contingency layer 501 may detect network related issues and based on the network related issues, determine a period or partial period of disruption. For instance, the contingency layer 501 may be implemented as a function of the network layer 102 and analyze network metrics such as throughput, traffic, and errors within the network layer.

Once the contingency layer 501 detects that a period or partial period of disruption has ended, the contingency layer 501 may resume pushing log data from the plurality of clients 201A-C to the aggregation layer 202 where they may be aggregated prior to transmitting to the ingestion system 104. For example, the contingency layer 501 may determine, based on the broker registry of the discovery system 303 that aggregation tasks 304A-C are available to receive data streams from the plurality of clients 201A-C.

Raw log data streams which have been ingested and stored in the computing system 103 may be processed offline by an instance of the aggregation layer 202. For instance, the aggregation layer 202 may be configured to determine data streams that were directly streamed to the ingestion system 104 during the period or partial period of disruption. For instance, the contingency layer 501 may indicate these log data streams based on error logs pushed during the period or partial period, metrics indicating higher throughput during the period or partial period, etc. Once raw log data has been identified, the aggregation layer can be applied (e.g., in a container, etc.) to reduce the storage capacity of the storage system 105.

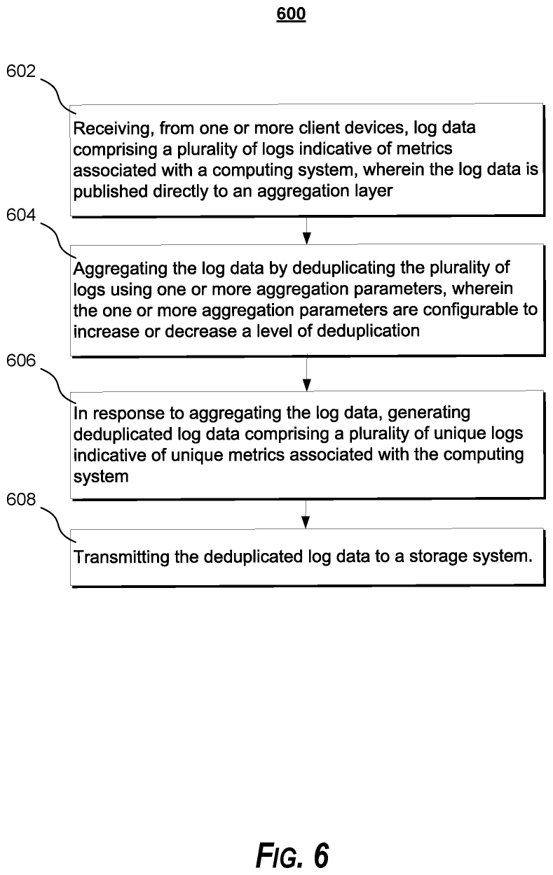

FIG. 6 depicts a flowchart diagram of an example method according to example aspects of the present disclosure. One or more portion(s) of the method 600 may be implemented by one or more computing devices such as, for example, the computing devices/systems described in FIGS. 2, 3, 4, 5, etc. Moreover, one or more portion(s) of the method 600 may be implemented as an algorithm on the hardware components of the device(s) described herein. For example, a computing system may include one or more processors and one or more non-transitory, computer-readable media storing instructions that are executable by the one or more processors to cause the computing system to perform operations, the operations including one or more of the operations/portions of method 600. FIG. 6 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, or modified in various ways without deviating from the scope of the present disclosure.

In an embodiment, the method 600 may include a step 602 or otherwise begin by receiving, from one or more client devices, log data including a plurality of logs indicative of metrics associated with a computing system, wherein the log data is published directly to an aggregation layer. For instance, clients (e.g., clients 101, clients 201A-C, etc.) may be included in a client-server relationship where independent or dependent services (e.g., microservices, etc.) of an application computing system (e.g., application server) communicate over one or more networks with application clients (e.g., clients 101, clients 201A-C, etc.).

The clients can include desktop clients, web browsing clients, application clients, and the like. The clients 101 may be running on one or more client devices (e.g., desktop, mobile devices, etc.) and facilitate communications with one or more servers of the computing system 103. For instance, the clients 101 may include a client program (e.g., software) that consumes services provided by a server program (e.g., computing system 103). The clients 101 may request data or other services (e.g., microservices, etc.) from the one or more servers of the computing system 103 by calling functions in the server application (e.g., computing system 103) over one or more networks. The clients 101 may generate log data as a user interacts with the clients 101 on a client device and the clients 101 interact with the computing system 103. For instance, log data may be generated based on user actions, requests from the clients 101, client performance, network events, etc.

In an embodiment, the method 600 may include a step 604 or otherwise continue by aggregating the log data by deduplicating the plurality of logs using one or more aggregation parameters, wherein the one or more aggregation parameters are configurable to increase or decrease a level of deduplication. For instance, an aggregation layer 202 may ephemerally receive log data from a plurality of clients 201A-C. The aggregation layer may include one or more aggregation tasks 304A-C configured to process log data streams from one or more clients (e.g., clients 101, clients 201A-C, etc.). The one or more aggregation tasks 304A-C may be configured to deduplicate log data streams based on one or more aggregation parameters.

By way of example, aggregation tasks 304A-C may be configured to aggregate log data based on a timestamp aggregation parameter. The timestamp aggregation parameter may group together log files within the log data which share a common time stamp or have a timestamp within a predetermined or dynamic duration. For instance, aggregation tasks 304A-C, may be configured to group together error log messages which have a common timestamps within a one minute interval. In some implementations, and aggregation tasks 304A-C may be configured to group together error log messages which have common timestamps within a ten second interval.

The timestamp aggregation parameter may increase or decrease the level of deduplication of the log files. For instance, data streams which include high cardinality log data at a rate of fifty thousand events per second may have an increased level of deduplication if a timestamp aggregation parameter associated with a one minute interval were applied due to the increased number of duplicative logs which are grouped together (e.g., during one minute) as opposed to a ten second time interval where a fewer number of log files may be grouped together (e.g., during ten seconds). The aggregation parameter may be adjusted and configured based on the client (e.g., client_id, etc.), log type (e.g., error event, security event, etc.), or any other log data characteristic.

In an embodiment, the method 600 may include a step 606 or otherwise continue by, in response to aggregating the log data, generating deduplicated log data comprising a plurality of unique logs indicative of unique metrics associated with the computing system. For instance, the aggregation layer 202 may group together all log files pushed from the clients over a one minute span, ten second span, etc. (e.g., timestamp aggregation parameter) and encode the variant data (e.g., client_id, log type, etc.). The result may generate deduplicated log data where fewer log files may represent the thousands of raw log files pushed from the respective clients over the specified duration or timestamp. The deduplicated log data may be smaller in size than the raw log data and may lower the traffic throughput for the computing system 103. For instance, raw log data (high cardinality, duplicative, etc.) can cause high throughput traffic when pushed from client 201B and 201C. The aggregation layer 202 (e.g., network layer 102) may reduce the high throughput by deduplicating the log data and generating a low throughput data stream including the deduplicated log data (e.g., fewer number of log files) which will be ingested by the computing system 103. Deduplicated log data may be transmitted to the computing system 103 as a low throughput data stream.

In an embodiment, the method 600 may include a step 608 or otherwise continue by transmitting the deduplicated log data to a storage system. For instance, the aggregation layer 202 may transmit the deduplicated log data to an ingestion system 104 where the log data may be processed and stored. Data ingestion may include streaming various types of log data from multiple sources (e.g., clients 101, aggregation layer 202 etc.) and storing the log data in a data store where it may be accessed and analyzed by analytical applications 112.

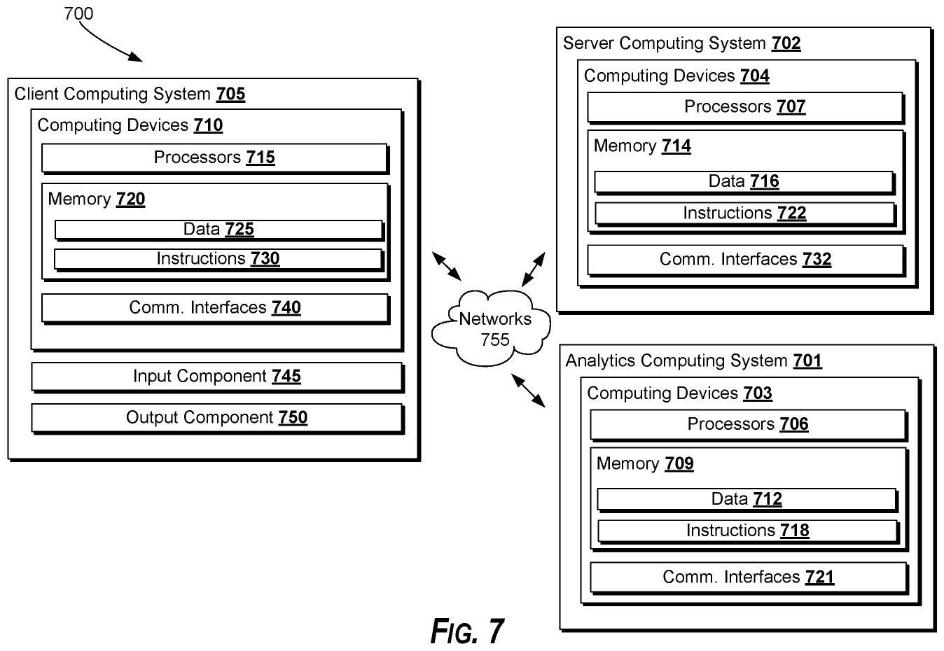

FIG. 7 depicts a block diagram of an example system 700 for implementing systems and methods according to example embodiments of the present disclosure. The example system 700 illustrated in FIG. 7 is provided as an example only. The components, systems, connections, and/or other aspects illustrated in FIG. 7 are optional and are provided as examples of what is possible, but not required, to implement the present disclosure. The example system 700 can include a client computing system 705 (e.g., clients 101, 201A-C, client devices, etc.). The example system 700 can include a server computing system 702 (e.g., computing system 103, etc.). The example system 700 can include an analytics computing system 701 (e.g., consumers 402A-C, analytical applications 112, etc.). One or more of the client computing system 705, the server computing system 702, or the analytics computing system 701 can be communicatively coupled to one another over one or more communication network(s) 755. The networks 755 can correspond to any of the networks described herein.

The computing device(s) 710 of the client computing system 705 can include processor(s) 715 and a memory 720. The one or more processors 715 can be any suitable processing device (e.g., a processor core, a microprocessor, an ASIC, a FPGA, a controller, a microcontroller, etc.) and can be one processor or a plurality of processors that are operatively connected. The memory 720 can include one or more non-transitory computer-readable storage media, such as RAM, ROM, EEPROM, EPROM, one or more memory devices, flash memory devices, data registrar, etc., and combinations thereof.

The memory 720 can store information that can be accessed by the one or more

processors 715. For example, the memory 720 (e.g., one or more non-transitory computer-readable storage mediums, memory devices, etc.) can include computer-readable instructions 1330A that can be executed by the one or more processors 715. The instructions 730 can be software written in any suitable programming language or can be implemented in hardware. Additionally, or alternatively, the instructions 730 can be executed in logically and/or virtually separate threads on processor(s) 715.

For example, the memory 720 can store instructions 730 that when executed by the one or more processors 715 cause the one or more processors 715 (e.g., of the client computing system 705, etc.) to perform operations such as any of the operations and functions of the computing system(s) (e.g., operations computing system, etc.) described herein (or for which the system(s) are configured), one or more of the operations and functions for communicating between the computing systems, one or more portions/operations of method 600, and/or one or more of the other operations and functions of the computing systems described herein.

The memory 720 can store processors 715 that can be obtained (e.g., acquired, received, retrieved, accessed, created, stored, etc.). The data 725 can include, for example, any of the data/information described herein. In some implementations, the computing device(s) 710 can obtain data from one or more memories that are remote from the client computing system 705.

The computing device(s) 705 can also include a communication interface 740 used to communicate with one or more other system(s) remote from the client computing system 705, such as server computing system 702, and/or the analytics computing system 701. The communication interface 740 can include any circuits, components, software, etc. for communicating via one or more networks (e.g., network(s) 755, etc.). The communication interface 740 can include, for example, one or more of a communications controller, receiver, transceiver, transmitter, port, conductors, software and/or hardware for communicating data.

The server computing system 702 can include one or more computing device(s) 704 that are remote from the client computing system 705 and the analytics computing system 701. The computing device(s) 704 can include one or more processors 707 and a memory 714. The one or more processors 707 can be any suitable processing device (e.g., a processor core, a microprocessor, an ASIC, a FPGA, a controller, a microcontroller, etc.) and can be one processor or a plurality of processors that are operatively connected. The memory 714 can include one or more tangible, non-transitory computer-readable storage media, such as RAM, ROM, EEPROM, EPROM, one or more memory devices, flash memory devices, data registrar, etc., and combinations thereof.

The memory 714 can store information that can be accessed by the one or more processors 707. For example, the memory 714 (e.g., one or more tangible, non-transitory computer-readable storage media, one or more memory devices, etc.) can include computer-readable instructions 722 that can be executed by the one or more processors 707. The instructions 722 can be software written in any suitable programming language or can be implemented in hardware. Additionally, or alternatively, the instructions 722 can be executed in logically and/or virtually separate threads on processor(s) 707.

For example, the memory 714 can store instructions 722 that when executed by the one or more processors 707 cause the one or more processors 707 to perform operations such as any of the operations and functions of the computing system(s) (e.g., advertisement server, etc.) described herein (or for which the system(s) are configured), one or more of the operations and functions for communicating between computing systems, one or more portions/operations of method 600 and/or one or more of the other operations and functions of the computing systems described herein. The memory 714 can store data 716 that can be obtained. The data 716 can include, for example, any of the data/information described herein.

The computing device(s) 704 can also include a communication interface 732 used to communicate with one or more system(s) that are remote from the system 702. The communication interface 732 can include any circuits, components, software, etc. for communicating via one or more networks (e.g., network(s) 755, etc.). The communication interface 732 can include, for example, one or more of a communications controller, receiver, transceiver, transmitter, port, conductors, software and/or hardware for communicating data.

The analytics computing system 701 can include one or more computing device(s) 703 that are remote from the client computing system 705 and the server computing system 702. The computing device(s) 703 can include one or more processors 706 and a memory 709. The one or more processors 706 can be any suitable processing device (e.g., a processor core, a microprocessor, an ASIC, a FPGA, a controller, a microcontroller, etc.) and can be one processor or a plurality of processors that are operatively connected. The memory 709 can include one or more tangible, non-transitory computer-readable storage media, such as RAM, ROM, EEPROM, EPROM, one or more memory devices, flash memory devices, data registrar, etc., and combinations thereof.

The memory 709 can store information that can be accessed by the one or more processors 706. For example, the memory 709 (e.g., one or more tangible, non-transitory computer-readable storage media, one or more memory devices, etc.) can include computer-readable instructions 718 that can be executed by the one or more processors 706. The instructions 715 can be software written in any suitable programming language or can be implemented in hardware. Additionally, or alternatively, the instructions 718 can be executed in logically and/or virtually separate threads on processor(s) 706.

For example, the memory 709 can store instructions 718 that when executed by the one or more processors 706 cause the one or more processors 706 to perform operations such as any of the operations and functions of the computing system(s) (e.g., user devices, etc.) described herein (or for which the user device(s) are configured), one or more of the operations and functions for communicating between systems, one or more portions/operations of method 600 and/or one or more of the other operations and functions of the computing systems described herein. The memory 709 can store data 712 that can be obtained. The data 712 can include, for example, any of the data/information described herein.

The computing device(s) 703 can also include a communication interface 721 used to communicate computing device/system that is remote from the analytics computing system 701, such as server computing system 702 or client computing system 705. The communication interface 721 can include any circuits, components, software, etc. for communicating via one or more networks (e.g., network(s) 755, etc.). The communication interface 721 can include, for example, one or more of a communications controller, receiver, transceiver, transmitter, port, conductors, software and/or hardware for communicating data.

The network(s) 755 can be any type of network or combination of networks that allows for communication between devices. In some implementations, the network(s) 755 can include one or more of a local area network, wide area network, the Internet, secure network, cellular network, mesh network, peer-to-peer communication link and/or some combination thereof and can include any number of wired or wireless links. Communication over the network(s) 755 can be accomplished, for example, via a communication interface using any type of protocol, protection scheme, encoding, format, packaging, etc.

Computing tasks discussed herein as being performed at certain computing device(s)/systems may instead be performed at another computing device/system, or vice versa.

Such configurations may be implemented without deviating from the scope of the present disclosure. The use of computer-based systems allows for a great variety of possible configurations, combinations, and divisions of tasks and functionality between and among components. Computer-implemented operations may be performed on a single component or across multiple components. Computer-implemented tasks or operations may be performed sequentially or in parallel. Data and instructions may be stored in a single memory device or across multiple memory devices.

The technology discussed herein makes reference to servers, databases, software applications, and other computer-based systems, as well as actions taken, and information sent to and from such systems. The inherent flexibility of computer-based systems allows for a great variety of possible configurations, combinations, and divisions of tasks and functionality between and among components. For instance, processes discussed herein may be implemented using a single device or component or multiple devices or components working in combination. Databases and applications may be implemented on a single system or distributed across multiple systems. Distributed components may operate sequentially or in parallel.

Aspects of the disclosure have been described in terms of illustrative implementations thereof. Numerous other implementations, modifications, or variations within the scope and spirit of the appended claims may occur to persons of ordinary skill in the art from a review of this disclosure. Any and all features in the following claims may be combined or rearranged in any way possible. Accordingly, the scope of the present disclosure is by way of example rather than by way of limitation, and the subject disclosure does not preclude inclusion of such modifications, variations or additions to the present subject matter as would be readily apparent to one of ordinary skill in the art. Moreover, terms are described herein using lists of example elements joined by conjunctions such as “and,” “or,” “but,” etc. It should be understood that such conjunctions are provided for explanatory purposes only. The term “or” and “and/or” may be used interchangeably herein. Lists joined by a particular conjunction such as “or,” for example, may refer to “at least one of” or “any combination of” example elements listed therein, with “or” being understood as “and/or” unless otherwise indicated. Also, terms such as “based on” should be understood as “based at least in part on.”

Those of ordinary skill in the art, using the disclosures provided herein, will understand that the elements of any of the claims discussed herein may be adapted, rearranged, expanded, omitted, combined, or modified in various ways without deviating from the scope of the present disclosure. Some implementations are described with a reference numeral, for example illustrated purposes and are not meant to be limiting.

What is claimed is:

1. A computer-implemented method comprising:
receiving, from one or more client devices, log data comprising a plurality of logs indicative of metrics associated with a computing system, wherein the log data is received by an aggregation layer;
aggregating the log data by deduplicating the plurality of logs using one or more aggregation parameters, wherein the one or more aggregation parameters are configurable to increase or decrease a level of deduplication;
in response to aggregating the log data, determining deduplicated log data comprising one or more unique logs indicative of unique metrics associated with the computing system; and
transmitting the deduplicated log data to a storage system.

2. The computer-implemented method of claim 1, wherein the log data has at least one of: (i) a higher throughput than the deduplicated log data or (ii) a higher cardinality than the deduplicated log data.

3. The computer-implemented method of claim 1, wherein the aggregation layer is provided as part of a network layer.

4. The computer-implemented method of claim 1, wherein the log data is ephemerally received by the aggregation layer.

5. The computer-implemented method of claim 1, further comprising:
accessing the deduplicated log data from the storage system; and
computing analytics data based on the deduplicated log data, the analytics data being associated with the log data.

6. The computer-implemented method of claim 1, wherein the one or more aggregation parameters comprises metadata associated with the plurality of logs.

7. The computer-implemented method of claim 6, wherein the metadata comprises at least one of: (i) a time stamp or (ii) a log type associated with respective logs of the plurality of logs.

8. The computer-implemented method of claim 1, further comprising:
determining the aggregation layer is unavailable to receive additional log data; and
based on determining the aggregation layer is unavailable to receive the additional log data, transmitting the additional log data to the storage system.

9. The computer-implemented method of claim 8, wherein determining the aggregation layer is unavailable to receive the additional log data comprises determining one or more faults associated with the aggregation layer, wherein the one or more faults are indicative of a fault tolerance.

10. A computing system comprising:
one or more processors; and
one or more non-transitory computer-readable medium storing instructions that are executable by the one or more processors to cause the computing system to perform operations, the operations comprising:
receiving, from one or more client devices, log data comprising a plurality of logs indicative of metrics associated with the computing system, wherein the log data is received by an aggregation layer;
aggregating the log data by deduplicating the plurality of logs using one or more aggregation parameters, wherein the one or more aggregation parameters are configurable to increase or decrease a level of deduplication;
in response to aggregating the log data, determining deduplicated log data comprising one or more unique logs indicative of unique metrics associated with the computing system; and
transmitting the deduplicated log data to a storage system.

11. The computing system of claim 10, wherein the log data has at least one of: (i) a higher throughput than the deduplicated log data or (ii) a higher cardinality than the deduplicated log data.

12. The computing system of claim 10, wherein the aggregation layer is provided as part of a network layer.

13. The computing system of claim 10, wherein the log data is ephemerally received by the aggregation layer.

14. The computing system of claim 10, wherein the operations further comprise:
accessing the deduplicated log data from the storage system; and
computing analytics data based on the deduplicated log data, the analytics data being associated with the log data.

15. The computing system of claim 10, wherein the one or more aggregation parameters comprises metadata associated with the plurality of logs.

16. The computing system of claim 15, wherein the metadata comprises at least one of: (i) a time stamp or (ii) a log type associated with respective logs of the plurality of logs.

17. The computing system of claim 10, wherein the operations further comprise:
determining the aggregation layer is unavailable to receive additional log data; and
based on determining the aggregation layer is unavailable to receive the additional log data, transmitting the additional log data to the storage system.

18. The computing system of claim 17, wherein determining the aggregation layer is unavailable to receive the additional log data comprises determining one or more faults associated with the aggregation layer, wherein the one or more faults are indicative of a fault tolerance.

19. A non-transitory computer-readable medium storing instructions that are executable by one or more processors to perform operations, the operations comprising:
receiving, from one or more client devices, log data comprising a plurality of logs indicative of metrics associated with a computing system, wherein the log data is received by an aggregation layer;
aggregating the log data by deduplicating the plurality of logs using one or more aggregation parameters, wherein the one or more aggregation parameters are configurable to increase or decrease a level of deduplication;
in response to aggregating the log data, determining deduplicated log data comprising one or more unique logs indicative of unique metrics associated with the computing system; and
transmitting the deduplicated log data to a storage system.

20. The non-transitory computer-readable medium of claim 19, wherein the log data has at least one of: (i) a higher throughput than the deduplicated log data or (ii) a higher cardinality than the deduplicated log data.
